(19) United States
(12) Patent Application Publication
(10) Pub. No.: US 2005/0187789 A1
(43) Pub. Date: Aug. 25, 2005

(54) Advanced patient and medication therapy management system and method

(75) Inventors: John Hatlestad, Maplewood, MN (US); Qingsheng Zhu, Little Canada, MN (US); Marina V. Brockway, Shoreview, MN (US)

Correspondence Address: Merchant & Gould P.C., P.O. Box 2903, Minneapolis, MN, 55402-0903, US

(73) Assignee: Cardiac Pacemakers, Inc.

(21) Appl. No.: 10/787,045

(22) Filed: Feb. 25, 2004

(51) Int. Cl. G06F 17/60

(52) U.S. Cl. 705/2

(57) ABSTRACT

A patient medication consumption and prescription regimen management system. The system includes a containment unit that is configured to accessibly house medication. The containment unit includes a control system that monitors patient medication consumption, and provides reminders to the patient to take scheduled doses of medication(s). The system further includes a health management host system that is coupled wirelessly or via an internet connection to the containment unit and provides a care provider with the ability to monitor patient medication use, along with other patient physiological parameters in assessing patient medication regimen compliance and medication regimen applicability to a patients medical condition.

### TECHNICAL FIELD

The present disclosure relates generally to advanced patient management systems. More particularly, the present disclosure relates to advanced patient management systems including a medication therapy compliance management component. The system is configured to collect and analyze patient physiological and medication therapy compliance data and adjust patient therapy based on the data. The system further includes a method for improved patient medication regimen compliance.

### BACKGROUND

Management of patients with chronic disease consumes a significant proportion of the total health care expenditure in the United States. Many of these diseases are widely prevalent and have significant annual incidences as well. Heart failure prevalence alone is estimated at over 5.5 million patients in 2000 with incidence rates of over half a million additional patients annually, resulting in a total health care burden in excess of $20 billion. Heart failure, like many other chronic diseases such as asthma, COPD, chronic pain, and renal failure, is event driven, where acute de-compensations result in hospitalization. In addition to causing considerable physical and emotional trauma to the patient and family, event driven hospitalizations consume a majority of the total health care expenditure allocated to the treatment of heart failure.

Hospitalization and treatment for an acute de-compensation typically occurs after the de-compensation event has happened. However, most heart failure patients exhibit prior non-traumatic symptoms, such as steady weight gain, in the weeks or days prior to the de-compensation. If the caregiver is aware of these symptoms, it is possible to intervene before the event, at substantially less cost to the patient and the health care system. Intervention is usually in the form of a re-titration of the patient's drug cocktail, reinforcement of the patient's compliance with the prescribed drug regimen, or acute changes to the patient's diet and exercise. Such intervention is usually effective in preventing the de-compensation episode and thus avoiding hospitalization.

Patients with chronic heart disease can receive implantable cardiac devices such as pacemakers, implantable cardioverter defibrillators (ICDs), and heart failure cardiac resynchronization therapy (CRT) devices. Currently, the electro physiologist that implants pacemakers and ICDs requires their patients to make clinic visits periodically, usually once every three or four months, in order to verify if their implanted device is working correctly and programmed optimally. Device follow-ups are usually performed by the nurse-staff assisted by the sales representative from the device manufacturers. Device follow-ups are labor intensive and typically require patients to make multiple clinic visits.

The data the caregiver does receive regarding a patient requires the caregiver to analyze the data and provide predictive and post-event diagnosis based on the data. However, as the amount of data collected regarding a particular patient increases, it becomes more difficult for a caregiver to assimilate and provide a meaningful analysis of all of the data all of the data. In addition, it is difficult for a caregiver to identify trends and other information from particular patients and leverage this knowledge for the treatment of larger populations.

It would therefore be desirable to develop an automated system to collect data regarding the physiological condition of a patient, the patient's compliance with the prescribed drug regimen as well as collect data from implanted devices, and to automate the process of analyzing the data.

### SUMMARY

This disclosure relates to the concept of a medication therapy management system. The system includes a containment unit that is configured to accessibly house medication. The containment unit includes a control system that monitors patient medication consumption and provides the containment unit with the ability to generate visual or auditory reminders of when a patient is to consume a scheduled dose of medication(s). The system further includes a health management host system that is coupled via an Internet, satellite or wireless connection to the containment unit and provides a patient wellness manager with the ability to monitor patient medication use, along with other patient physiological parameters in assessing patient medication regimen compliance and medication regimen applicability to a patient's medical condition. In one embodiment, the host system further provides for the processing of patient medication regimen compliance data along with patient physiological parameters whereby the host system automatically determines whether the medication regimen should be modified. If the host system automatically determines that a medication regimen should be modified, the modified regimen is displayed to a patient wellness manager who may confirm and transmit the modified medicine regimen to the containment unit and a pharmacy for prescription revision.

In another embodiment, the medication therapy management system is configured to receive patient physiological data from an external source, such as a cardiac rhythm management device. Such data is processed and displayed along with the patient medication compliance data to determine whether the medication regimen should be modified.

These and various other features as well as advantages which characterize the present invention will be apparent from a reading of the following detailed description and a review of the associated drawings.

### BRIEF DESCRIPTION OF THE DRAWINGS

The invention may be more completely understood in consideration of the following detailed description of various embodiments of the invention in connection with the accompanying drawings, in which:

FIG. 1 illustrates an example advanced patient management system made in accordance with the present invention;

FIG. 2 illustrates an example computer system made in accordance with the present invention;

FIG. 3 illustrates an embodiment of an electronic medication therapy management device;

FIG. 4 illustrates an embodiment of an electronic medication therapy management device communications and control system;

FIG. 5 illustrates an example interrogator/transceiver unit made in accordance with the present invention; and

FIG. 6 illustrates an example communication system made in accordance with the present invention.

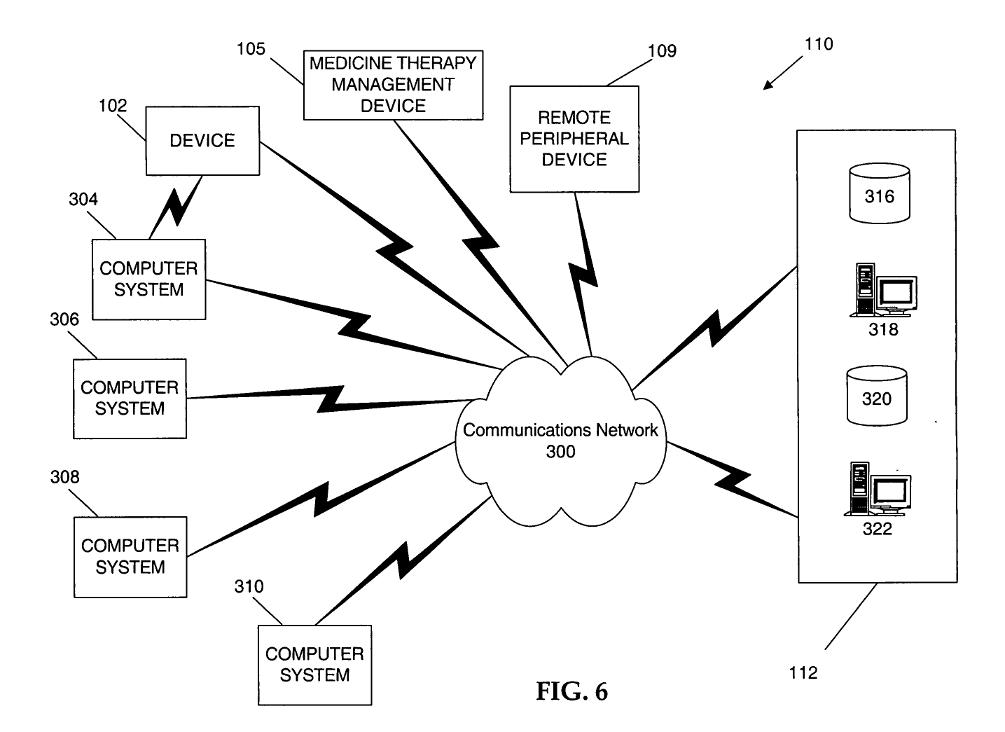

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present system and methods are described with respect to an advanced patient management system configured to collect patient-specific information, store and collate the information, and generate actionable recommendations to enable the predictive management of patients. The advanced patient management system is also configured to leverage a remote communications infrastructure to provide automatic device follow-ups to collect data, coordinate therapy, and to determine if remote devices are functioning properly. The term “patient” is used herein to mean any individual from whom information is collected. The term “caregiver” is used herein to mean any provider of services, such as health care providers including, but not limited to, nurses, doctors, and other health care provider staff.

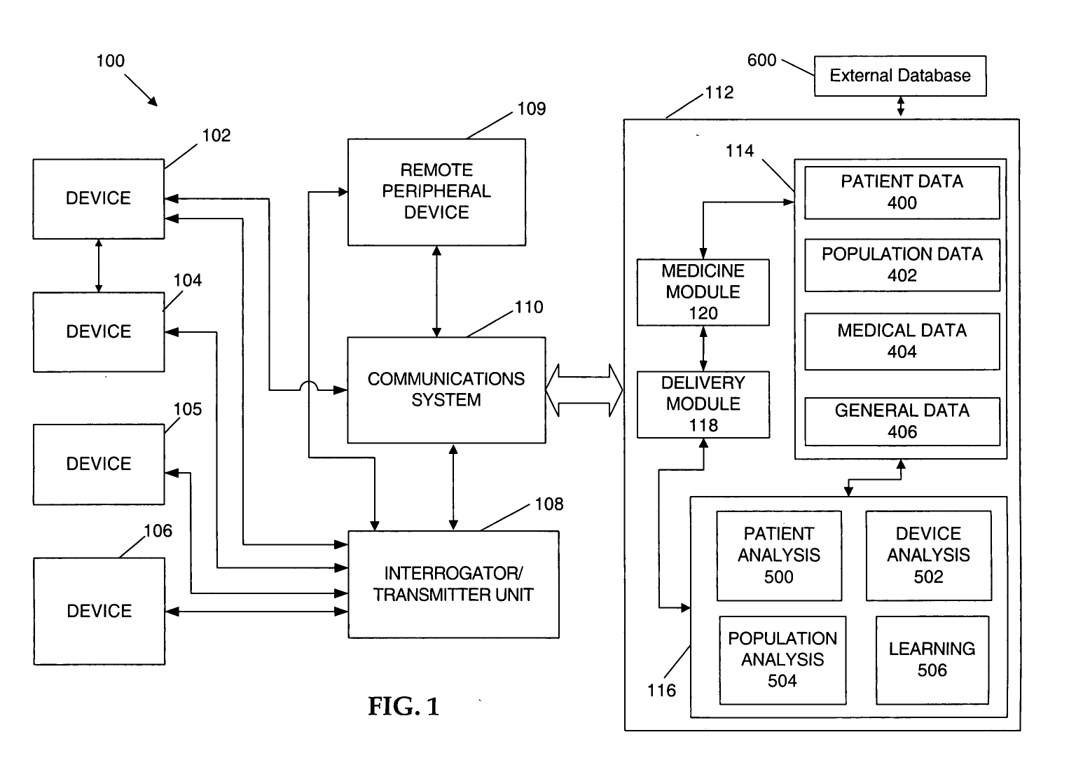

FIG. 1 illustrates an example advanced patient management system 100 made in accordance with the present invention. Advanced patient management system 100 generally includes the following components: one or more devices 102, 104, 105 and 106, one or more interrogator/transceiver units 108, a communication system 110, one or more remote peripheral devices 109, and a host 112.

Each component of the advanced patient management system 100 can communicate using the communication system 110. Some components may also communicate directly with one another. For example, devices 102 and 104 and devices 105 and 106 may be configured to communicate directly with one another. The various components of the example advanced patient management system 100 illustrated herein are described below.

I. Devices

Devices 102, 104, 105 and 106 can be implantable devices or external devices. In the present embodiment, device 105 is an external medication therapy management device. All of these devices 102, 104, 105, 106 may provide one or more of the following functions with respect to a patient: (1) sensing, (2) data analysis, (3) therapy, (4) data recordation, reception and transmission. For example, in one embodiment, devices 102, 104, 105 and 106 are either implanted or external devices used to measure a variety of physiological, subjective, and environmental conditions of a patient using electrical, mechanical, and/or chemical means. The devices 102, 104, 105 and 106 may be configured to automatically gather data or may require manual intervention by the patient. The devices 102, 104, 105, and 106 may be configured to store data related to the physiological and/or subjective measurements and/or transmit the data to the communication system 110 using a variety of methods, described in detail below. Although four devices 102, 104, 105, and 106 are illustrated in the example embodiment shown, more or fewer devices may be used for a given patient.

The devices 102, 104, 105, and 106 can be configured to analyze the measured data and act upon the analyzed data. For example, the devices 102, 104, 105, and 106 may be configured to modify therapy or provide alarm indications based on the analysis of the data. The devices 102, 104, 105 and 106 may also be configured to manage and administer therapy and record data associated with the administration of such therapy. Therapy can be provided automatically or in response to an external communication. Devices 102, 104, 105, and 106 are programmable in that the characteristics of their sensing, therapy (e.g., duration and interval), or communication can be altered by communication between the devices 102, 104, 105, and 106 and other components of the advanced patient management system 100. Devices 102, 104, 105, and 106 can also perform self-checks or be interrogated by the communication system 110 to verify that the devices are functioning properly. Examples of different embodiments of the devices 102, 104, 105, and 106 are provided below.

Devices implanted within the body have the ability to sense and communicate as well as to provide therapy. Implantable devices can provide direct measurement of characteristics of the body, including, without limitation, electrical cardiac activity (e.g., a pacemaker, cardiac resynchronization management device, defibrillator, etc.), physical motion, temperature, heart rate, activity, blood pressure, breathing patterns, ejection fractions, blood viscosity, blood chemistry, blood glucose levels, and other patient-specific clinical physiological parameters, while minimizing the need for patient compliance.

A heart rhythm sensor, typically found in a pacemaker or defibrillator, is one example of an implantable device. In the heart, an electrical wave activates the heart muscle just prior to contraction. As is known in the art, electrical circuits and lead-wires transduce the heart's activation event and reject other, non-essential electrical events. By measuring the time interval between activation events, the heart rhythm can be determined. A transthoracic impedance sensor is another example of a sensor in an implantable device. During the respiratory cycle, large volumes of air pass into and out of the body. The electrical resistance of the thorax changes markedly as a result of large differences in conductivity of air and body tissues. The thoracic resistance can be measured during respiration and converted into a measurable electrical signal (i.e., impedance) so that breathing rate and profile can be approximated. Implantable devices can also sense chemical conditions, such as glucose levels, blood oxygen levels, etc. Further, the advanced patient management system 100 may utilize other implantable devices as well that provide physiological measurements of the patient, such as drug pumps, neurological devices (e.g., stimulators), oxygen sensors, etc.

Derived measurements can also be determined from the implantable device sensors. For example, a sleep sensor can rely on measurements taken by an implanted accelerometer that measures body activity levels. The sleep sensor can estimate sleeping patterns based on the measured activity levels. Other derived measurements include, but are not limited to, a functional capacity indicator, autonomic tone indicator, sleep quality indicator, cough indicator, anxiety indicator, and cardiovascular wellness indicator for calculating a quality of life indicator quantifying a patient's overall health and well-being.

Devices 102, 104, 105, and 106 can also be external devices, or devices that are not implanted in the human body, that are used to measure physiological data. Such devices include a multitude of devices to measure data relating to the human body, such as temperature (e.g., a thermometer), blood pressure (e.g., a sphygmomanometer), blood characteristics (e.g., glucose levels), body weight, physical strength, mental acuity, diet, heart characteristics, and relative geographic position (e.g., a Global Positioning System (GPS)).

Devices 102, 104, 105, and 106 can also be environmental sensors. The devices can be placed in a variety of geographic locations (in close proximity to patient or distributed throughout a population) and record non-patient specific characteristics such as, but not limited to, temperature, air quality, humidity, carbon monoxide level, oxygen level, barometric pressure, light intensity, and sound.

One or more of the devices 102, 104, 105, and 106 (for example, device 106) may be external devices that measure subjective or perceptive data from the patient. Subjective data is information related to a patient's feelings, perceptions, and/or opinions, as opposed to objective physiological data. For example, the “subjective” devices can measure patient responses to inquiries such as “How do you feel?” and “How is your pain?” The device can prompt the patient and record subjective data from the patient using visual and/or audible cues. For example, the patient can press coded response buttons or type an appropriate response on a keypad. Alternatively, subjective data may be collected by allowing the patient to speak into a microphone and using speech recognition software to process the subjective data.

In one example embodiment, the subjective device presents the patient with a relatively small number of responses to each question posed to the patient. For example, the responses available to the patient may include three faces representing feelings of happiness, nominalness, and sadness. Averaged over time, a trend of a patient's well being will emerge with a finer resolution than the quanta of the three responses.

The subjective data can be collected from the patient at set times, or, alternatively, collected whenever the patient feels like providing subjective data. The subjective data can also be collected substantially contemporaneously with physiological data to provide greater insight into overall patient wellness. The subjective device 106 can be any device that accepts input from a patient or other concerned individual and/or provides information in a format that is recognizable to the patient. Device 106 typically includes a keypad, mouse, display, handheld device, interactive TV, cellular telephone or other radio frequency (“RF”) communications device, cordless phone, corded phone, speaker, microphone, email message, or physical stimulus.

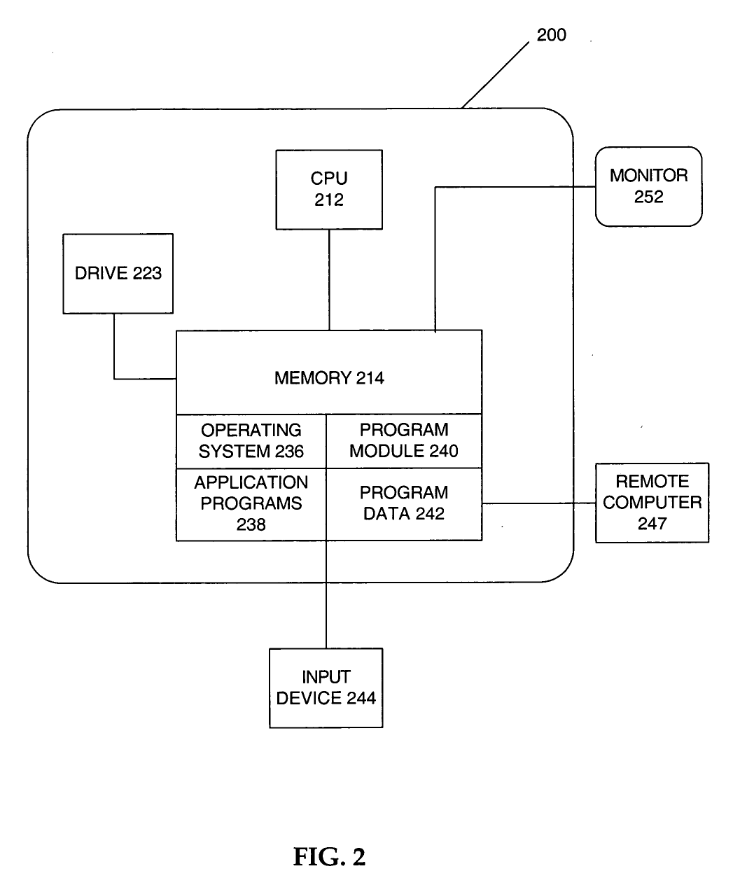

In one embodiment, the subjective device 106 includes or is part of a computer system 200, as illustrated in FIG. 2. The example computer system 200 includes a central processor unit 212 and a system memory 214. The computer system 200 further includes one or more drives 223 for reading data from and writing data to, as well as an input device 244, such as a keyboard or mouse, and a monitor 252 or other type of display device. A number of program modules may be stored on the drive 223, including an operating system 236, one or more application programs 238, other program modules 240, and program data 242. The computer system 200 can operate in a networked environment using logical connections to one or more remote computers or computer systems 247. Computer system 200 can also include hand-held computers such as a PDA computer.

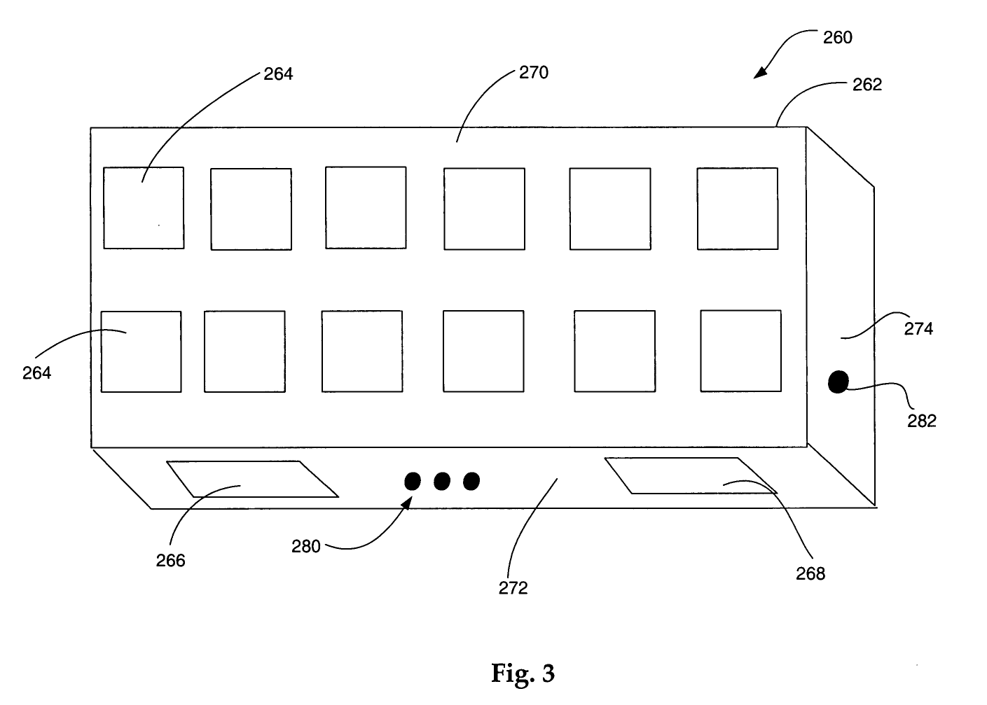

In a preferred embodiment, device 105 is a medication therapy management device that communicates with at least one implanted device 106 and an interrogator/transceiver unit 108, a communications system 110, one or more remote peripheral devices 109, and a host system 112. The medication therapy management device 105 provides a method for real-time monitoring of medication events. Medication events include when a patient removes or fails to remove medication from device 105. The containment unit 260 as illustrated in FIG. 3, is comprised of a housing 262, having a top wall 270 a bottom wall (not shown), a first sidewall 272, an opposing third sidewall (not shown), a second sidewall 274, an opposing a fourth sidewall (not shown), a communications window 266, an LCD display 268 and a plurality of pill receptacles 264. Communications window 266 provides a communications medium through which wireless communications may be transmitted. Each pill receptacle 264 has a cover (not shown) for securing closed the pill receptacle 264. During use of the medication therapy management device a patient receives visual and auditory notification of when it is time and the amount of medication that needs to be consumed. When the patient opens a pill receptacle 264 to remove medicine, the containment unit of the medication therapy management device records the time of when the pill receptacle 264 is opened and the medication is presumptively consumed and automatically communicates the information back to the host system 112. This information may also be communicated to the implanted device 106, which in one embodiment is a cardiac rhythm management (“CRM”) device. The visual notification of when it is time and the amount of medication that needs to be consumed may be in the form of a message displayed on an LCD display 268, or a flashing LED 280. The auditory notification of when it is time and the amount of medication that needs to be consumed may be in the form of a beeping, buzzing or vibrating alarm that continues until the patient disengages the auditory notification by pressing a button 282 or opening a containment unit pill receptacle 264 of the device 260. The auditory notification may also be in the form of a recorded message, such as “it is time to take your medication.” In an embodiment such as that the containment unit illustrated in FIG. 3 where there are multiple compartments for medicine storage, an LED could be made to flash on the appropriate containment unit medication receptacle that is to be opened at that time. It is also contemplated that the containment unit 260 illustrated in FIG. 3 is configured with multiple containment unit receptacles, so that one or more may be used to contain emergency medication. The medication therapy management control system further includes a communications and control system 211 that provides the medication therapy management control system with an interrogator/transceiver unit (ITU) 256 that provides the containment unit with a means for transmitting to and receiving communications from the communications system 110 and/or the host system 112 and a means for transmitting to and receiving communications from devices 102, 104, and 106. In one embodiment, device 106 is an implanted cardiac rhythm management (“CRM”) device that may communicate with the containment unit 260 directly or indirectly via CRM 106 communication with the host system 112.

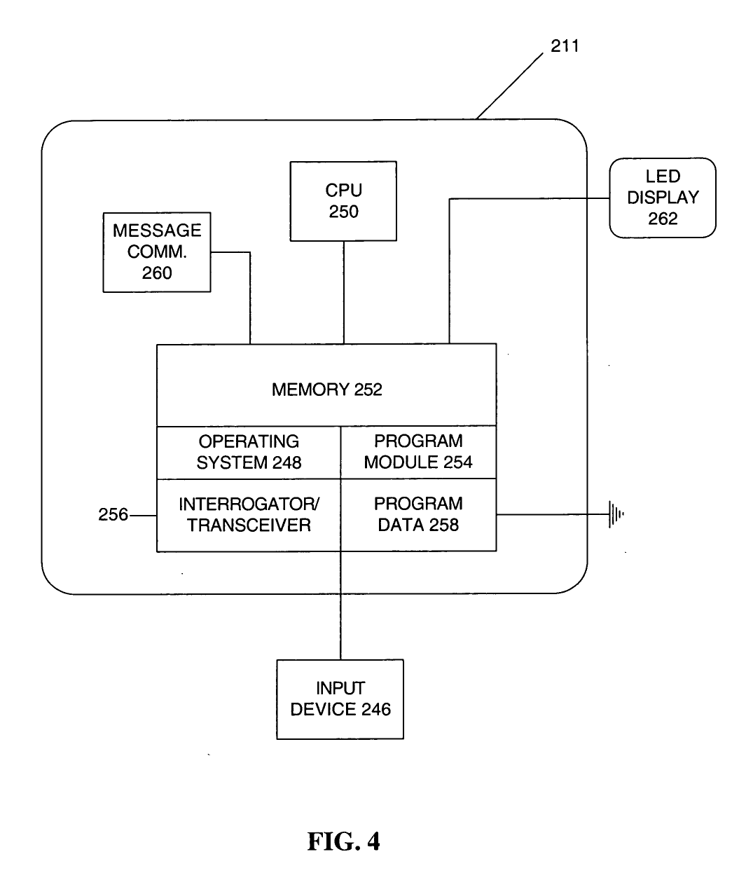

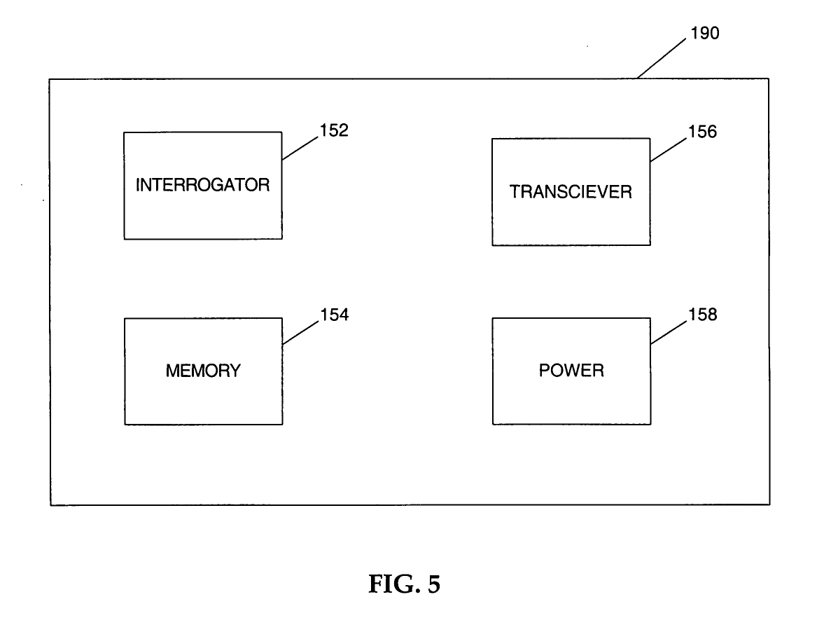

The medication therapy management device communications and control system 211, illustrated in FIG. 4, includes an input device, 246, for manual input of data, a central processor 250, memory 252, program module 254, program data 258, an interrogator/transceiver unit 256, an operating system 248, an antenna and a auditory and visual message communication 260. Auditory and visual messages are controlled by the CPU 250, program module 254 and program data 258. In addition to the auditory and visual messages generated by the containment unit related to medication consumption, it is contemplated that the system is configured for programming in such a manner that permits auditory and visual messages relating to a plurality of physiological health factors, including heart rate, fluid retention, weight and neuro-hormonal data. The interrogator/transceiver unit 256 is described in detail in relation to FIG. 5, which illustrates an interrogator/transceiver unit 256 in detail.

Communication of the medication therapy management device 105 with the host system 112 occurs automatically, pursuant to a previously programmed transmission of data interval or an inquiry from the host system 112. Communication of the medication therapy management device 260 with the host system 112 may also be prompted by the user of the medication therapy management device 105 by engaging a down load button. The communication with the host system 112 of the medication therapy management device 105 allows the caregiver to review patient medicine regimen compliance data along with patient physiological data related to the human body and specific heart functions and ICD device data. When such communications occur automatically in real-time and from a historical perspective it allows the caregiver to review patient medicine regimen compliance data along with patient physiological data related to the human body and specific heart functions and ICD device data. The medication therapy management device 105 may communicate with the host system 112 via an Internet connection, telephone or satellite transmission. Upon a caregiver's review of patient medicine regimen compliance data concurrent with patient physiological data related to the human body and specific heart functions and ICD device data, the caregiver can determine if changes in the patient medicine regimen is necessary in view of the patient data. If it is determined by the caregiver that the patient medicine regimen needs to be modified in view of the patient data analyzed, the revised patient medicine regimen may be programmed by the caregiver into the host system 112. The host system may then, upon instruction of the caregiver, transmit to the medication therapy management device 105, a pharmacy host system and the patient the revised medicine regimen.

The revised medicine regimen will include at least data representative of a prescription and prescription consumption schedule. The revised medicine regimen may be transmitted to the medication therapy management device 105 in order to reprogram the auditory and visual notifications relating to the patient's consumption schedule. The revised medicine regimen may then be transmitted to the pharmacy host system to expedite the patient's receipt of new medicine and proper dosage consumption by the patient.

The pharmacy may fill the prescription in its normal course by supplying the patient with a supply of medicine in a container, along with a medicine consumption schedule and instructions that are in accordance with the schedule defined by the physician. Alternatively, the patient may bring the containment unit 260 into the pharmacy and the pharmacist may transmit the revised medicine regimen data to data storage of the medication therapy management device and fill the prescription by way of including the requisite dosages in the containment unit 260 medication receptacles 264. The revised medicine regimen may be transmitted and programmed to the containment unit 260 data storage via wireless communication. Alternatively, the pharmacy may be equipped with an adaptor, docking station, or other physical connector that connects to the containment unit 260 and allows for the downloading of medicine regimen data to the containment unit 260 memory 252. The containment unit 260 notification functions may then be programmed by the pharmacist if it did not occur automatically from the host system communication of the revised medicine regimen. Alternatively, the medicine regimen data that needs to be programmed into the medication therapy management device 260 may be transmitted directly to the patient along with instructions on how to reprogram the medication therapy management device 260. The instructions may be transmitted to the patient in the form of mailed communication, electronic or paper. The patient may then reprogram the medication therapy management device 260 after the device medicine receptacles have been re-stocked with medicine that is consistent with the revised medicine regimen.

In an alternative embodiment, the host system includes a medicine module that processes the patient medicine regimen data along with patient physiological data and ICD device data and automatically in response thereto adjusts the patient medicine regime. The adjusted patient medicine regimen may include new instructions for consuming medication as well as new prescriptions. The instructions may be transmitted to the patient in the form of mailed communication, electronic or paper. The instructions may also be transmitted and programmed directly to the medication therapy management device so that patient auditory and visual instructions are immediately updated. In addition, the adjusted patient medicine regimen instructions may also be transmitted and programmed directly to a pharmacy's host system. The patient may be notified by the pharmacy that a new prescription is ready and that the medication therapy management device 260 should be brought to the pharmacy for refill or that a new prescription is ready for pick-up. When the patient visits the respective pharmacy for prescription modification and medication therapy management device refill, the information is already in the pharmacy host system. Alternatively, the medicine regimen data that needs to be programmed into the device may be transmitted directly to the patient along with instructions on how to reprogram the medication therapy management device. The patient or patient loved ones may then reprogram the medication therapy management device after the device has been re-stocked with medicine that is consistent with the revised medicine regimen.

The dispensing function of the present embodiment of the medication therapy management device 200 illustrated in FIG. 3 includes a separate compartment for each medication interval. The medication therapy management device configuration as illustrated in FIG. 3, assumes that medication intervals are once daily. It is contemplated that the medication therapy management device 260 would include the appropriate number of medication storage receptacles 264 so that the medication therapy management device includes enough compartments for the appropriate number of intervals for a day of the week, depending on the frequency of which medication is to be consumed by a patient. In the present embodiment a sensor records the opening of a medication therapy management device receptacle 264 and transmits the time that such opening occurred to the host system 112. In an alternative embodiment, there could be a separate pill receptacle for each type of medication, and a sensor connected to each medication receptacle 264. In yet another embodiment there could be a separate medication receptacle 264 for each separate medication and dosage to be taken. If a number of different medications were to be taken at the same time, the events would be recorded separately as each medication therapy management device receptacle 264 is opened. In another embodiment, there could be separate medication therapy management devices 260 for each prescribed medication, operating independent of the other devices as each medication therapy management device 260 independently communicates with the host system 112.

It is contemplated that all embodiments of the medication therapy management device include an over use module as part of the program data 254. The over use module equips the medication therapy management device with the ability to prevent over use or an inappropriate use of medication. The medication therapy management device is configured and controlled by the program data 254 to prevent inappropriate dispensation of medication by preventing the opening of a pill receptacle until the scheduled time for medication consumption. The over use module as well as other aspects of the medication therapy management device 260 communicates with the medicine module 120 of the host system to communicate inappropriate use of medication so that the caregiver may take steps to intervene and instruct the patient accordingly. It is also contemplated that the medication therapy management device pill receptacles 204 may be opened and/or closed in accordance with prescribed circumstances transmitted to the device 260 by the host system 112.

In the embodiment illustrated in FIG. 3, it is contemplated that the medication therapy management device 260 is a standalone device. It may be configured to record data and store trending data in device data storage 252 for transmission to a monitor for immediate display. The monitor may be a part of the medication therapy management device 200 or a separate device configured for electronic connection to the device 260. In the preferred embodiment, medication therapy management device 260 is configured to transmit and accept RF telemetry. This configuration provides for the transmission of medication compliance data stored in the device 260 data storage to the implanted CRM device. The implanted CRM device is configured to receive such data transmissions and stores the data received in implanted device data storage. The data received from the medication therapy management device 260 and stored by the implanted CRM device in implanted device data storage is transmitted to the host system 112 or a programmer along with all other data stored in implanted device data storage for transmission to the host system 112 by the implanted device.

It is further contemplated that the implanted device is configured to transmit communications to the medication therapy management device. In the preferred embodiment, such communications occur via RF transmissions. Under circumstances where the implanted device records patient data outside prescribed limits, or determines based on implanted device processing of implanted device data readings that the patient's condition has reached a status requiring emergency medication, the implanted device transmits a signal to the medication therapy management device to initiate an emergency indicator which is designed to instruct the patient to take emergency medication stored in an emergency medication receptacle of the medication therapy management device.

The advanced patient management system 100 may also include one or more remote peripheral devices 109. The remote peripheral device 109 may include, for example and without limitation, cellular telephones, pagers, PDA devices, facsimiles, remote computers, printers, video and/or audio devices, etc. The remote peripheral device 109 can communicate using wired or wireless technologies and may be used by the patient or caregiver to communicate with the communication system 110 and/or the host 112. For example, the remote peripheral device 109 can be used by the caregiver to receive alerts from the host 112 based on data collected from the patient and to send instructions from the caregiver to either the patient or other clinical staff. In another example, the remote peripheral device 109 is used by the patient to receive periodic or real time updates and alerts regarding the patient's health and well being.

II. Interrogrator/Transceiver Unit

Referring now to FIG. 5, an embodiment of the interrogator/transceiver unit 190 is illustrated. The interrogator/transceiver unit 190 is used in the device control system 211, illustrated in FIG. 4 as interrogator/transceiver unit 256. The interrogator/transceiver unit 190 is also used in the example advanced patient management system 100 as interrogator/transceiver unit 108, is shown. This interrogator/transceiver unit (“ITU”) 180 is also the type used in the example advanced patient management system 100 illustrate in FIG. 1. As illustrated in FIG. 5, the ITU 108 as used in the device control system 211 includes an interrogator module 152 for sending and receiving data from a device, such as a devices 102, 104, and 106 when they are internal CRM devices, a memory module 154 for storing data, and a transceiver module 156 for sending and receiving data to and from the components of the APM system 100. The transceiver module may also operate as an interrogator of the devices 102, 104 and 106. The ITU 108 also includes a power module 158 that provides power. The ITU 108 as used in an advanced patient management system illustrated in FIG. 1 includes an interrogator module 152 for sending and receiving data from a device, such as devices 102, 104, and 106, a memory module 154 for storing data, and a transceiver module 156 for sending and receiving data to and from other components of the APM system 100. The transceiver module may also operate as an interrogator of the devices 102, 104 and 106. The ITU 108 also includes a power module 158 that provides power.

The ITU 190 may perform one or more of the following functions: (1) data storage; (2) data analysis; (3) data forwarding; (4) patient interaction; (5) patient feedback; and (6) data communications. For example, the ITU 190 may facilitate communication of device 105 with devices 102, 104 and 106 and communications between the devices 102, 104, and 106 and the communication system 110. The ITU 190 can, periodically or in real-time, interrogate and download into memory clinically relevant patient data from the devices 102, 104, and/or 106. This data includes, in the cardiac sensor context, for example, P and R-wave measurements, pacing, shocking events, lead impedances, pacing thresholds, battery voltage, capacitor charge times, ATR episodes with electrograms, tachycardia episodes with electrograms, histogram information, and any other clinical information necessary to ensure patient health and proper device function. The data is sent to the ITU 190 by the devices 102, 104, and 106 in real-time or periodically uploaded from buffers in the devices.

The ITU 190 may also allow patient interaction. For example, the ITU 190 may include a patient interface and allow the patient to input subjective data, such as an updated medicine regimen. In addition, the ITU 190 controls feedback given to the patient regarding compliance with the medicine regimen. The feedback includes visual and auditory notification of when it is time and the amount of medication that needs to be consumed, based on information input into the medication therapy management device by the patient or information communicated to the ITU 190 or communication device 105 by the communication system 110.

In another embodiment, the ITU 190 includes a telemetry link from the devices to a network that forms the basis of a wireless LAN in the patient's home. The ITU 190 systematically uploads information from the devices 102, 104, and/or 106 while the patient is sleeping, for example. The uploaded data is transmitted through the communication system 110 or directly to the host 112. In addition, in one embodiment the ITU 190 functions in a hybrid form, utilizing wireless communication when available and defaulting to a local wireless portal or a wired connection when the wireless communication becomes unavailable.

Some devices, such as legacy implanted cardiac rhythm management (“CRM”) devices, communicate via an internal telemetry transceiver that communicates with an external programmer. The communication range of such devices is typically 1 to 4 inches. ITU 190 may include a special short-range interrogator that communicates with a legacy device.

In an alternative embodiment, the ITU 256 within the device control system 211, illustrated in FIG. 4, communicates with an additional ITU than may be in the form of a small device that is placed in an inconspicuous place within the patient's residence. Alternatively, the additional ITU may be implemented as part of a commonly-used appliance in the patient's residence. For example, the additional ITU may be integrated with an alarm clock that is positioned near the patient's bed. In another embodiment, the ITU may be implemented as part of the patient's personal computer system. Other embodiments are also possible.

An ITU 108, implemented as part of the example advanced patient management system 100 illustrated in FIG. 1, can perform analysis on the data and provide immediate feedback, as well as perform a variety of self-diagnostic tests to verify that it is functioning properly and that communication with the communication system 110 has not be compromised. For example, the ITU 108 can perform a diagnostic loop-back test at a time set by the host 112, which involves sending a request through the communication system 110 to the host 112. The host 112 can then reply with a response back through the communication system 110 to the ITU 108. If a specific duration elapses before the ITU 108 receives the response or the ITU 108 receives an unexpected response, or if the host 112 does not receive the diagnostic test communication, the ITU 108 can provide indications that the system is not functioning properly and the host 112 can alert an operator that there may be compromised communications with that specific ITU 108. For example, if wireless communications between the ITU 108 and the communication system 110 have been interrupted, and the ITU 108 performs a self-diagnostic test that fails, the ITU 108 may alert the patient so that corrective action may be taken. The alert can take the form of a sound or a visual and/or audible enunciator to alert the patient that communication has been interrupted. In another embodiment, the ITU 108 can automatically fail-back to a wired system to communicate with the communication system 110 and perform the same communications compromise checks.

In other embodiments of the advanced patient management system 100, the ITU 108 function can be integrated into devices 102, 104, 105 and 106, so that the devices can communicate directly with the communication system 110 and/or host 112. The devices 102, 104 and 106 can incorporate multi-mode wireless telecommunications such as cellular, BLUETOOTH, or IEEE 802.11B to communicate with the communication system 110 directly or through a local wireless to a wired portal in the patients' home. For example, device 102 may include a miniature cellular phone capable of wirelessly uploading clinical data from the device on a periodic basis. This is particularly advantageous for devices that are mobile (e.g., an implanted device in a patient that is traveling).

To conserve the energy of the devices 102, 104, and 106, particularly when the devices (e.g., device 102) are configured to communicate directly with the communication system 110 without communicating through the ITU 108, in one example embodiment the devices are configured to communicate during a given duty cycle. For example, the device 102 can be configured to communicate with the communication system 110 at given intervals, such as once a week. The device 102 can record data for the time period (e.g., a week) and transmit the data to the communication system 110 during the portion of the cycle that transmission is active and then conserve energy for the rest of the cycle. In another example, the device 102 conserves energy and only communicates with the communication system 110 when an “interesting” event, such as a heart arrhythmia, has occurred. In this manner, device 102 can communicate directly with the communication system 110 and/or host 112 without requiring communicating through an ITU 108, while conserving the energy of the device by communicating only during a given duty cycle.

The interrogation rate of the ITU 108 can be varied depending on disease state and other relevant factors. In addition, the devices 102, 104, and 106 can be configured to “wake up” frequently (e.g., once every couple minutes) to provide the ITU 108 an access window for the ITU 108 to provide commands to the devices 102, 104, and 106, as well as upload data from the devices.

If multiple devices, such as devices 102, 104, and 106, are provided for a given patient, each device may include its own means for communicating with the ITU 108 or communication system 110. Alternatively, a single telemetry system may be implemented as part of one of the devices, or separate from the devices, and each device 102, 104, and 106 can use this single telemetry system to communication with the ITU 108 or the communication system 110.

In yet another embodiment, the devices 102, 104, and 106 include wires or leads extending from devices 102, 104, and 106 to an area external of the patient to provide a direct physical connection. The external leads can be connected, for example, to the ITU 256 of device 105 to provide communications between the devices 102, 104, 106 and 105 and thereby the other components of the advanced patient management system 100.

The advanced patient management system 100 can also involve a hybrid use of the ITU 108. For example, the devices 102, 104, and 106 can intelligently communicate via short-range telemetry with the ITU when the patient is located within the patient's home and communicate directly with the communication system 110 or host 112 when the patient is traveling. This may be advantageous, for example, to conserve battery power when the devices are located near an ITU.

III. Communication System

Communication system 110 provides for communications between and among the various components of the advanced patient management system 100, such as the devices 102, 104, 105 and 106, host 112, and remote peripheral device 109. FIG. 4 illustrates one embodiment for the communication system 110 made in accordance with the present invention. The communication system 110 includes a plurality of computer systems 304, 306, 308, and 310, as well as device 102, host 112, and remote peripheral device 109, connected to one another by the communications network 300. The communications network 300 may be, for example, a local area network (LAN), wide area network (WAN), or the Internet. Communications among the various components, as described more fully below, may be implemented using wired or wireless technologies.

In the example embodiment illustrated, the host 112 includes server computers 318 and 322 that communicate with computers 304, 306, 308, and 310 using a variety of communications protocols, described more fully below. The server computers 318 and 322 store information in databases 316 and 320. This information may also be stored in a distributed manner across one or more additional servers.

A variety of communication methods and protocols may be used to facilitate communication between devices 102, 104, 105 and 106, ITU 108, communication system 110, host 112, and remote peripheral device 109. For example, wired and wireless communications methods may be used. Wired communication methods may include, for example and without limitation, traditional copper-line communications such as DSL, broadband technologies such as ISDN and cable modems, and fiber optics, while wireless communications may include cellular, satellite, radio frequency (RF), Infrared, etc.

For any given communication method, a multitude of standard and/or proprietary communication protocols may be used. For example and without limitation, protocols such as radio frequency pulse coding, spread spectrum, direct sequence, time-hopping, frequency hopping, SMTP, FTP, and TCP/IP may be used. Other proprietary methods and protocols may also be used. Further, a combination of two or more of the communication methods and protocols may also be used.

The various communications between the components of the advanced patient management system 100 may be made secure using several different techniques. For example, encryption and/or tunneling techniques may be used to protect data transmissions. Alternatively, a priority data exchange format and interface that are kept confidential may also be used. Authentication can be implemented using, for example, digital signatures based on a known key structure (e.g., PGP or RSA). Other physical security and authentication measures may also be used, such as security cards and biometric security apparatuses (e.g., retina scans, iris scans, fingerprint scans, veinprint scans, voice, facial geometry recognition, etc.). Conventional security methods such as firewalls may be used to protect information residing on one or more of the storage media of the advanced patient management system 100. Encryption, authentication and verification techniques may also be used to detect and correct data transmission errors.

Communications among the various components of the advanced patient management system 100 may be enhanced using compression techniques to allow large amounts of data to be transmitted efficiently. For example, the devices 102, 104, and 106 or the ITU 108 may compress the recorded information prior to transmitting the information to the ITU 108 or directly to the communication system 110.

The communication methods and protocols described above can facilitate periodic and/or real-time delivery of data.

IV. Host

The example host 112 includes a database module 114, an analysis module 116, and a delivery module 118 (see FIG. 1). Host 112 preferably includes enough processing power to analyze and process large amounts of data collected from each patient, as well as to process statistics and perform analysis for large populations. For example, the host 112 may include a mainframe computer or multi-processor workstation. The host 112 may also include one or more personal computer systems containing sufficient computing power and memory. The host 112 may include storage medium (e.g., hard disks, optical data storage devices, etc.) sufficient to store the massive amount of high-resolution data that is collected from the patients and analyzed.

The host 112 may also include identification and contact information (e.g., IP addresses, telephone numbers, or a product serial number) for the various devices communicating with it, such as ITU 108 and peripheral device 109. For example, each ITU 108 is assigned a hard-coded or static identifier (e.g., IP address, telephone number, etc.), which allows the host 112 to identify which patient's information the host 112 is receiving at a given instant. Alternatively, each device 102, 104, and 106 may be assigned a unique identification number, or a unique patient identification number may be transmitted with each transmission of patient data.

When a device is first activated, several methods may be used to associate data received by the advanced patient management system 100 with a given patient. For example, each device may include a unique identification number and a registration form that is filled out by the patient, caregiver, or field representative. The registration form can be used to collect the necessary information to associate collected data with the patient. Alternatively, the user can logon to a web site to allow for the registration information to be collected. In another embodiment, a barcode or RFID tag is included on each device that is scanned prior to or in conjunction with deployment of the device to provide the information necessary to associate the recorded data with the given patient.

Referring again to FIG. 1, the example database module 114 includes a patient database 400, a population database 402, a medical database 404, and a general database 406, all of which are described further below.

The patient database 400 includes patient specific data, including data acquired by the devices 102, 104, 105 and 106. The patient database 400 also includes a patient's medical records. The patient database 400 can include historical information regarding the devices 102, 104, 105 and 106. For example, if device 102 is an implantable cardioverter defibrillator (ICD), the patient database 400 records the following device information: P and R measurements, pacing frequency, pacing thresholds, shocking events, recharge time, lead impedance, battery voltage/remaining life, ATR episode and EGMs, histogram information, and other device-specific information. The information stored in the database 400 can be recorded at various times depending on the patient requirements or device requirements. For example, the database 400 is updated at periodic intervals that coincide with the patient downloading data from the device. Alternatively, data in the database 400 can be updated in real time. Typically, the sampling frequency depends on the health condition being monitored and the co-morbidities.

The population database 402 includes non-patient specific data, such as data relating to other patients and population trends. The population database 402 also records epidemic-class device statistics and patient statistics. The population database 402 also includes data relating to staffing by health care providers, environmental data, pharmaceuticals, etc.

The example medical database 404 includes clinical data relating to the treatment of diseases. For example, the medical database 404 includes historical trend data for multiple patients in the form of a record of progression of their disease(s) along with markers of key events.

The general database 406 includes non-medical data of interest to the patient. This can include information relating to news, finances, shopping, technology, entertainment, and/or sports. The general database 406 can be customized to provide general information of specific interest to the patient. For example, stock information can be presented along with the latest health information as detected from the devices 102, 104, 105 and 106.

In another embodiment, information is also provided from an external source, such as external database 600. For example, the external database 600 includes external medical records maintained by a third party, such as drug prescription records maintained by a pharmacy, providing information regarding the type of drugs that have been prescribed for a patient.

The example analysis module 116 includes a patient analysis module 500, device analysis module 502, population analysis module 504, and learning module 506.

Patient analysis module 500 may utilize information collected by the advanced patient management system 100, as well as information for other relevant sources, to analyze data related to a patient and provide timely and predictive assessments of the patient's well-being. In performing this analysis, the patient device module 500 may utilize data collected from a variety of sources, include patient specific physiological and subjective data collected by the advanced patient management system 100, medical and historical records (e.g., lab test results, histories of illnesses, etc., drugs currently and previously administered, etc.), as well as information related to population trends provided from sources external to the advanced patient management system 100.

For example, in one embodiment, the patient analysis module 500 makes a predictive diagnosis of an oncoming event based on information stored in the database module 114. For example, the data continuously gathered from a device of a given patient at a heightened risk for a chronic disease event (such as de-compensations in heart failure) is analyzed. Based on this analysis, therapy, typically device-based or pharmaceutical, is then be applied to the patient either through the device or through clinician intervention. The system could also issue an alert to a caregiver.

In another example embodiment, the patient analysis module 500 provides a diagnosis of patient health status and predicted trend based on present and recent historical data collected from a device as interpreted by a system of expert knowledge derived from working practices within clinics. For example, the patient analysis module 500 performs probabilistic calculations using currently-collected information combined with regularly-collected historical information to predict patient health degradation.

In another example embodiment, the patient analysis module 500 may conduct pre-evaluation of the incoming data stream combined with patient historical information and information from patients with similar disease states. The pre-evaluation system is based on data derived from working clinical practices and the records of outcomes. The derived data is processed in a neural network, fuzzy logic system, or equivalent system to reflect the clinical practice. Further, the patient analysis module 500 may also provide means for periodic processing of present and historical data to yield a multidimensional health state indication along with disease trend prediction, next phase of disease progression co-morbidities, and inferences about what other possible diseases may be involved. The patient analysis module 500 may also integrate data collected from internal and external devices with subjective data to optimize management of overall patient health.

Device analysis module 502 analyzes data from the devices 102, 104, 105 and 106 and ITU 108 to predict and determine device issues or failures. For example, if an implanted device 102 fails to communicate at an expected time, device analysis module 502 determines the source of the failure and takes action to restore the performance of the device 102. The device analysis module 502 may also perform additional deterministic and probabilistic calculations. For example, the device analysis module 502 gathers data related to charge levels within a given device, such as an ICD, and provides analysis and alerting functions based on this information if, for example, the charge level reaches a point at which replacement of the device and/or battery is necessary. Similarly, early degradation or imminent failure of implanted devices can be identified and proactively addressed, or at-risk devices can be closely monitored.

Population analysis module 504 uses the data collected in the database module 114 to manage the health of a population. For example, a clinic managing cardiac patients can access the advanced patient management system 100 and thereby obtain device-supplied advance information to predict and optimize resource allocation both as to immediate care and as a predictive metric for future need of practicing specialists. As another example, the spread of disease in remote populations can be localized and quarantined rapidly before further spread.

In one embodiment, population analysis module 504 trends the patient population therapy and management as recorded by the devices and directs health care resources to best satisfy the needs of the population. The resources can include people, facilities, supplies, and/or pharmaceuticals. In other embodiments, the population analysis module detects epidemics and other events that affect large population groups. The population analysis module 504 can issue alerts that can initiate a population quarantine, redirect resources to balance size of staffing with number of presenting population, and predict future need of qualified specialists.

The population analysis module 504 may utilize a variety of characteristics to identify like-situated patients, such as, for example, sex, age, genetic makeup, etc. The population analysis module 504 may develop large amounts of data related to a given population based on the information collected by the advanced patient management system 100. In addition, the population analysis module 504 may integrate information from a variety of other sources. For example, the population analysis module 504 may utilize data from public domain databases (e.g., the National Institute of Health), public and governmental and health agency databases, private insurance companies, medical societies (e.g., the American Heart Association), and genomic records (e.g., DNA sequences).

In one embodiment of the invention, the host 112 may be used as a “data clearinghouse,” to gather and integrate data collected from the devices 102, 104, 105 and 106, as well as data from sources outside the advanced patient management system 100. The integrated data can be shared with other interested entities, subject to privacy restrictions, thereby increasing the quality and integration of data available.

Learning module 506 analyzes the data provided from the various information sources, including the data collected by the advanced patient system 100 and external information sources. For example, the learning module 506 analyzes historical symptoms, diagnoses, and outcomes along with time development of the diseases and co-morbidities. The learning module 506 can be implemented via a neural network (or equivalent expert) system.

The learning module 506 can be partially trained (i.e., the learning module 506 may be implemented with a given set of preset values and then learn as the advanced patient management system functions) or untrained (i.e., the learning module 506 is initiated with no preset values and must learn from scratch as the advanced patient management system functions). In other alternative embodiments, the learning module 506 may continue to learn and adjust as the advanced patient management system functions (i.e., in real time), or the learning module 506 may remain at a given level of learning and only advanced to a higher level of understanding when manually allowed to do so.

In a neural network embodiment, new clinical information is presented to create new neural network coefficients that are distributed as a neural network knowledge upgrade. The learning module 506 can include a module for verifying the neural network conclusions for clinical accuracy and significance. The learning module can analyze a database of test cases, appropriate outcomes and relative occurrence of misidentification of the proper outcomes. In some embodiments, the learning module 506 can update the analysis module 116 when the analysis algorithms exceed a threshold level of acceptable misidentifications.

The example learning module 506 uses various algorithms and mathematical modeling such as, for example, trend and statistical analysis, data mining, pattern recognition, cluster analysis, neural networks, Bayesian (probabilistic) networks and fuzzy logic. Learning module 506 may perform deterministic and probabilistic calculations. Deterministic calculations include algorithms for which a clear correlation is known between the data analyzed and a given outcome. For example, there may be a clear correlation between the energy left in a battery of an implantable device and the amount of time left before the battery must be replaced.

A probabilistic calculation involves the correlation between data and a given outcome that is less than 100 percent certain. Probabilistic determinations require an analysis of several possible outcomes and an assignment of probabilities for those outcomes (e.g., an increase in weight of a patient may, at a 25% probability, signal an impending de-compensation event and/or indicate that other tests are needed). The learning module 506 performs probabilistic calculations and selects a given response based on less than a 100% probability. Further, as the learning module 506 “learns” for previous determinations (e.g., through a neural network configuration), the learning module 506 becomes more proficient at assigning probabilities for a given data pattern, thereby being able to more confidently select a given response. As the amount of data that has been analyzed by the learning module 506 grows, the learning module 506 becomes more and more accurate at assigning probabilities based on data patterns. A bifurcated analysis may be performed for diseases exhibiting similar symptoms. As progressive quantities of data are collected and the understanding of a given disease state advances, disease analysis is refined where a former singular classification may split into two or more sub-classes.

In addition, patient-specific clinical information can be stored and tracked for hundreds of thousands of individual patients, enabling a first-level electronic clinical analysis of the patient's clinical status and an intelligent estimate of the patient's short-term clinical prognosis. The learning module 506 is capable of tracking and forecasting a patient's clinical status with increasing levels of sophistication by measuring a number of interacting co-morbidities, all of which may serve individually or collectively to degrade the patient's health. This enables learning module 506, as well as caregivers, to formulate a predictive medical response to oncoming acute events in the treatment of patients with chronic diseases such as heart failure, diabetes, pain, cancer, and asthma/COPD, as well as possibly head-off acute catastrophic conditions such as MI and stroke.

Delivery module 118 coordinates the delivery of feedback based on the analysis performed by the host 112. In response to the analysis module 116, delivery module 118 can manage the devices 102, 104, 105 and 106, perform diagnostic data recovery, program the devices, and otherwise deliver information as needed. In some embodiments, the delivery module 118 can manage a web interface that can be accessed by patients or caregivers. The information gathered by an implanted device can be periodically transmitted to a web site that is securely accessible to the caregiver and/or patient in a timely manner. In other embodiments, a patient accesses detailed health information with diagnostic recommendations based upon analysis algorithms derived from leading health care institutions.

For example, the caregiver and/or patient can access the data and analysis performed on the data by accessing one or more general content providers. In one example, the patient's health information is accessed through a general portal such as My Yahoo provided by Yahoo! Inc. of Sunnyvale, Calif. A patient can access his or her My Yahoo homepage and receive information regarding current health and trends derived from the information gathered from the devices 102, 104, 105 and 106, as well as other health information gathered from other sources. The patient may also access other information in addition to health information on the My Yahoo website, such as weather and stock market information. Other electronic delivery methods such as email, facsimile, etc. can also be used for alert distribution.

In an alternative embodiment, the data collected and integrated by the advanced patient system 100, as well as any analysis performed by the system 100, is delivered by delivery module 118 to a caregiver's hospital computer system for access by the caregiver. A standard or custom interface facilitates communication between the advanced patient management system 100 and a legacy hospital system used by the caregiver so that the caregiver can access all relevant information using a system familiar to the caregiver.

The advanced patient management system 100 can also be configured so that various components of the system (e.g., ITU 108, communication system 110, and/or host 112) provide reporting to various individuals (e.g., patient and/or caregiver). For example, different levels of reporting can be provided by (1) the ITU 108 and (2) the host 112. The ITU 108 may be configured to conduct rudimentary analysis of data gathered from devices 102, 104,105 and 106, and provide reporting should an acute situation be identified. For example, if the ITU 108 detects that a significant heart arrhythmia is imminent or currently taking place, the ITU 108 provides reporting to the patient in the form of an audible or visual alarm before administering therapy.

The host 112 can provide a more sophisticated reporting system. For example, the host 112 can provide exception-based reporting and alerts that categorize different reporting events based on importance. Some reporting events do not require caregiver intervention and therefore can be reported automatically. In other escalating situations, caregiver and/or emergency response personnel need to become involved. For example, based on the data collected by the advanced patient management system 100, the delivery module 118 can communicate directly with the devices 102, 104, 105 and 106, contact a pharmacy to order a specific medication for the patient, and/or contact 911 emergency responses. In an alternative embodiment, the delivery module 118 and/or the patient may also establish a voice communication link between the patient and a caregiver, if warranted.

In addition to forms of reporting including visual and/or audible information, the advanced patient management system 100 can also communicate with and reconfigure one or more of the devices 102, 104, 105 and 106. For example, if device 102 is part of a cardiac rhythm management system, the host 112 can communicate with the device 102 and reconfigure the therapy provided by the cardiac rhythm management system based on the data collected from one or more of the devices 102, 104, 105 and 106. In another embodiment, the delivery module 118 can provide to the ITU 108 recorded data, an ideal range for the data, a conclusion based on the recorded data, and a recommended course of action. This information can be displayed on the ITU 108 for the patient to review or made available on the peripheral device 109 for the patient and/or clinician to review.

One or more headings have been provided above to assist in describing the various embodiments disclosed herein. The use of headings, and the resulting division of the description by the headings, should not be construed as limiting in any way. The subject matter described under one heading can be combined with subject matter described under one or more of the other headings without limitation and as desired.

The systems and methods of the present disclosure can be implemented using a system as shown in the various figures disclosed herein including various devices and/or programmers, including implantable or external devices. Accordingly, the methods of the present disclosure can be implemented: (1) as a sequence of computer implemented steps running on the system; and (2) as interconnected modules within the system. The implementation is a matter of choice dependent on the performance requirements of the system implementing the method of the present disclosure and the components selected by or utilized by the users of the method. Accordingly, the logical operations making up the embodiments of the method of the present disclosure described herein can be referred to variously as operations, steps, or modules. It will be recognized by one of ordinary skill in the art that the operations, steps, and modules may be implemented in software, in firmware, in special purpose digital logic, analog circuits, and any combination thereof without deviating from the spirit and scope of the present invention as recited within the claims attached hereto.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

1. A medication storage, therapy and consumption management system, comprising:
a containment unit configured to accessibly house medication; and
a health management host system coupled to the containment unit in a manner that allows data transmission,
said containment unit including a communications and control system that records and transmits data relating to a medication event, said containment unit control system further providing for transmitting and receiving medication therapy data;
said health management host system configured to receive data related to the medication event, receive patient physiological data, analyze and display the patient physiological data and the medical event data on a health management display.

2. The system of claim 1, wherein the patient physiological data comprises weight, fluid retention data, data monitored by an implantable device and neuro-hormonal data.

3. The system of claim 1, wherein the containment unit is further configured to communicate wirelessly with said health management host system.

4. The system of claim 1, wherein the containment unit is configured with a display device to illustrate a medication therapy strategy.

5. The system of claim 4, wherein the containment unit is configured to receive data from an external source and further configured to transmit such data to the health management host system.

6. The system of claim 1, wherein the containment unit is further configured to notify the patient when it is time to take the medication housed therein.

7. The system of claim 1, wherein the containment unit is further configured to communicate a request for a medication re-fill with a pharmacy system when the quantity of the medication is below a pre-determined level.

8. The system of claim 1, wherein said health management host system processes said data related to the medication event data and said patient physiological data, and in response thereto provides for the generation of an updated medication therapy regimen.

9. An electronic patient health management system, comprising:
a medical measurement device for measuring data related to at least one patient physiological health factor;
a medication therapy management device, configured to house medication and store data related to patient consumption of medication, the medication therapy management device further configured for interrogating the medical measurement device and processing the data retrieved from the medical measurement device and the data related to patient consumption of medication; and
a patient wellness host system, communicatively coupled to the medication therapy management device, configured to receive and display the processed data.

10. The system of claim 9, wherein the medication therapy management device is further configured to provide a reminder to a patient when it is time to take the medication.

11. The system of claim 9, wherein the medical measurement device is a external measurement device.

12. The system of claim 9, wherein the medical measurement device is an implantable device.

13. The system of claim 9, wherein the medical measurement device is communicatively coupled to the patient wellness host system via an Internet connection.

14. The system of claim 9, wherein the medical measurement device is communicatively coupled to the patient wellness host system via a wireless communication link.

15. The system of claim 9, wherein data related to the at least one patient physiological health factor comprises fluid retention data.

16 The system of claim 11, wherein data related to the at least one patient physiological health factor comprises data monitored by an implantable device.

17. The system of claim 11, wherein data related to the at least one patient physiological health factor comprises weight data.

18. The system of claim 11, wherein data related to the at least one patient physiological health factor comprises neuro-hormonal data.

19. The system of claim 9, wherein data related to the at least one patient physiological health factor comprises renal function data.

20. The patient wellness host system of claim 9 further configured to process said data received in order to develop and display a therapeutic response.

21. The system of claim 19, wherein the developed therapeutic response comprises revising medication regime, maintaining current medication regime, and recommending a diet plan.

22. The system of claim 9, wherein the patient wellness host system is a computer, which comprises with a memory, a processor and a user interface.

23. The system of claim 9, wherein the medication diagnostic device communicates with the patient wellness host system to alert the wellness manager that the medication level is below a pre-determined level.

24. A method for remote management of a medication therapy via utilizing a medication containment unit whereby the method comprises the following steps:
alerting a patient when it is time to carry out a step of a first therapeutic plan;
sensing when the medication containment unit is engaged and recording the same as a medication event;
receiving patient physiological data;
processing said patient physiological data and said medication event data; and
generating a second therapeutic plan in response to said processing of said patient physiological data and said medication event data.

25. The method of claim 23, wherein the alerting step comprises notifying the patient consume at least one of the following, medication, and food.

26. The method of claim 23, wherein the alerting step comprises causing the medication containment unit to generate one of the following, an audible sound, to vibrate and to communicate with a second external device which responsively prompts the patient to act.

27. The method of claim 23, wherein the receiving step is initiated by an external device transmitting patient physiological data to the containment unit.

28. The method of claim 23, wherein the receiving step is initiated when the containment unit interrogates an external device.
